(19) United States
(12) Patent Application Publication
(10) Pub. No.: US 2016/0192436 A1
(43) Pub. Date: Jun. 30, 2016

(54) APPARATUS, SYSTEM AND METHOD OF DISCONNECTING A WIRELESS LINK

(71) Applicant: INTEL CORPORATION, SANTA CLARA, CA (US)

(72) Inventors: Lei Shao, Sunnyvale, CA (US); Xintian E. Lin, Mountain View, CA (US); Ulun Karacaoglu, San Jose, CA (US)

(21) Appl. No.: 14/582,593

(22) Filed: Dec. 24, 2014

(51) Int. Cl. H04W 76/06; G09G 5/14; G09G 5/12; H04W 4/04

(52) U.S. Cl. CPC H04W 76/06; H04W 4/043; G09G 5/14; G09G 5/12; G09G 2354/00; G09G 2370/16

(57) ABSTRACT

Some demonstrative embodiments include apparatuses, devices, systems and methods of disconnecting a wireless link. For example, a mobile device may include a radio to communicate with a wireless display in a room to share content from the mobile device on the wireless display over a wireless link between the mobile device and the wireless display; and a controller to determine whether or not the mobile device is out of the room, and, if the mobile device is determined to be out of the room, to initiate disconnection of the wireless link between the mobile device and the wireless display.

### TECHNICAL FIELD

Embodiments described herein generally relate to disconnecting a wireless link.

### BACKGROUND

A mobile device, e.g., a laptop, a Smartphone, a Tablet, and/or the like, may communicate with a wireless display to display content from the mobile device on the wireless display.

The wireless display may include a wireless projector in a conference room to display the content to one or more people in the conference room.

The conference room may be public and/or available to other people, and the content may be secure, sensitive, confidential, and or private.

Therefore, it may be desirable not to expose the content to unauthorized people.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic flow chart illustration of a method of determining whether or not a mobile device is out of a room, in accordance with some demonstrative embodiments.

FIG. 3 is a schematic sequence diagram of operations between a mobile device and a wireless display, in accordance with some demonstrative embodiments.

FIG. 4 is a schematic flow chart illustration of a method of disconnecting a wireless link, in accordance with some demonstrative embodiments.

FIG. 5 is a schematic illustration of a product of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, a User Equipment (UE), a Mobile Device (MD), a wireless station (STA), a Bluetooth device, an Internet of Things (IoT) device, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing IEEE 802.11 standards (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012; IEEE802.11ac-2013 (“IEEE P802.11ac-2013, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 4: Enhancements for Very High Throughput for Operation in Bands below 6 GHz”, December, 2013); IEEE 802.11ad (“IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band”, 28 December, 2012); IEEE 802.11Revmc; IEEE 802.11x) and/or future versions and/or derivatives thereof, devices and/or networks operating in accordance with existing Wireless Fidelity (WiFi) Alliance (WFA) Peer-to-Peer (P2P) specifications (WiFi P2P technical specification, version 1.2, 2012) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, devices and/or networks operating in accordance with existing WirelessHD™ specifications and/or future versions and/or derivatives thereof, units and/or devices which are part of the above networks, devices and/or networks operating in accordance with existing Intel Wireless Display (WiDi) specifications and/or future versions and/or derivatives thereof, devices and/or networks operating in accordance with existing Miracast™ specifications and/or future versions and/or derivatives thereof, units and/or devices which are part of the above networks, and the like.

Some embodiments may be used in conjunction with one way and/or two-way radio communication systems, a Miracast Device, a WiDi device, a Miracast sink, a Miracast source, a wireless display device, a video source, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device.

Some demonstrative embodiments may be used in conjunction with a WLAN. Other embodiments may be used in conjunction with any other suitable wireless communication network, for example, a wireless area network, a “piconet”, a WPAN, a WVAN and the like.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a set of switched beam antennas, and/or the like.

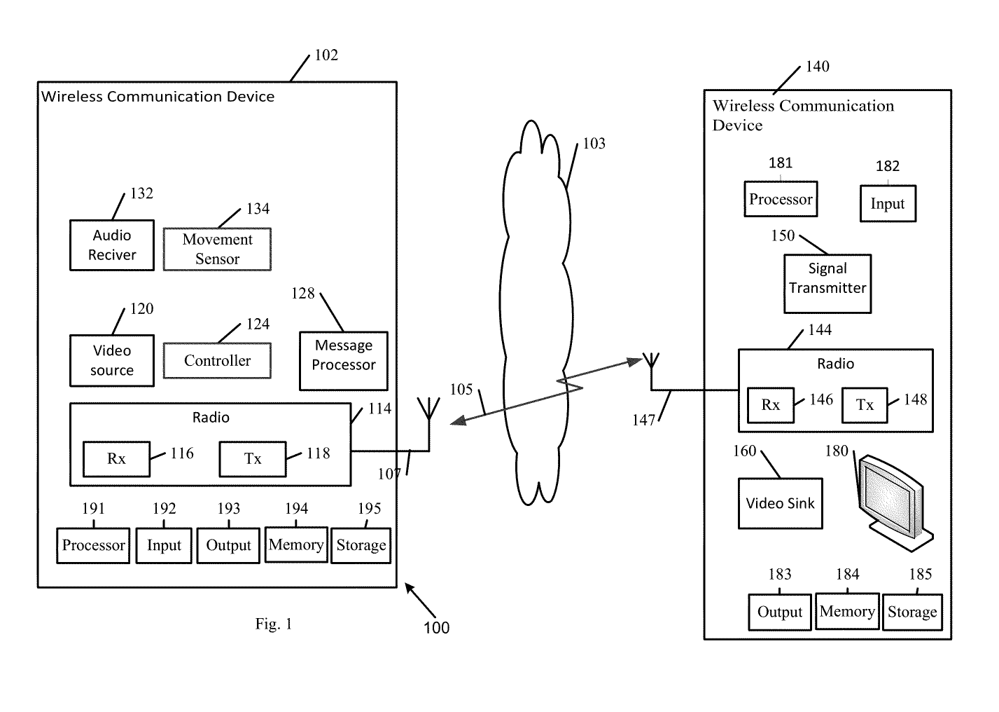

Reference is now made to FIG. 1, which schematically illustrates a block diagram of a system 100, in accordance with some demonstrative embodiments.

As shown in FIG. 1, in some demonstrative embodiments, system 100 may include one or more wireless communication devices capable of communicating content, data, information, audio, video, and/or signals via a wireless medium (WM) 103. For example, system 100 may include a wireless communication device 102, and/or wireless communication device 140.

In some demonstrative embodiments, wireless communication device 102 may include a video source device.

In some demonstrative embodiments, wireless communication device 102 may include a video source 120.

In some demonstrative embodiments, video source 120 may include a Miracast video source, a Wireless Display (WiDi) video source, or any other video source.

In some demonstrative embodiments, wireless communication device 140 may include a wireless display device.

In some demonstrative embodiments, wireless communication device 140 may include a video sink 160 to receive content from video source 120 via WM 103.

In some demonstrative embodiments, video sink 160 may include a Miracast sink, a Wireless Display (WiDi) sink, or any other video sink.

In some demonstrative embodiments, wireless communication device 140 may include a display device 180 to display the content, e.g., received via video sink 160.

In some demonstrative embodiments, display device 180 may include a projector, television (TV), an LCD screen, a LED screen, or the like.

In some demonstrative embodiments, display device 180 and video sink 160 may be part of device 140.

In one example, device 140 may include a wireless projector having an embedded projector and a video sink module and/or capabilities.

In other embodiments, at least one of display device 180 and video sink 160 may not be part of device 140.

In one example, video sink 160 may not be part of device 140. For example, device 140 may include a TV, and video sink 160 may include a box or a plug attached to the TV, configured to provide video sink capabilities to the TV.

In another example, display device 180 may not be part of device 140. For example, display device 180 may include a TV, which does not have wireless capabilities, and device 140 may include a box or a plug attached to the TV, configured to provide video sink and/or wireless capabilities to the TV.

In some demonstrative embodiments, device 102 may include a mobile device.

In some demonstrative embodiments, wireless communication device 102, may include, for example, a mobile computer, a laptop computer, a User Equipment (UE), an Internet of Things (IoT) device, a notebook computer, a tablet computer, an Ultrabook™ computer, a mobile internet device, a handheld computer, a handheld device, a PDA device, a handheld PDA device, a hybrid device (e.g., combining cellular phone functionalities with PDA device functionalities), a consumer device, a mobile or portable device, a mobile phone, a cellular telephone, a PDA device which incorporates a wireless communication device, a mobile or portable GPS device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a video source, a Personal Media Player (PMP), a digital video camera (DVC), a gaming device, a Digital Still camera (DSC), a media player, a Smartphone, or the like.

In some demonstrative embodiments, device 102 may include, for example, one or more of a processor 191, an input unit 192, an output unit 193, a memory unit 194, and a storage unit 195; and/or device 140 may include, for example, one or more of a processor 181, an input unit 182, an output unit 183, a memory unit 184, and a storage unit 185. Devices 102 and/or 140 may optionally include other suitable hardware components and/or software components. In some demonstrative embodiments, some or all of the components of one or more of devices 102 and/or 140 may be enclosed in a common housing or packaging, and may be interconnected or operably associated using one or more wired or wireless links. In other embodiments, components of one or more of devices 102 and/or 140 may be distributed among multiple or separate devices.

Processor 191 and/or processor 181 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 executes instructions, for example, of an Operating System (OS) of device 102 and/or of one or more suitable applications. Processor 181 executes instructions, for example, of an Operating System (OS) of device 140 and/or of one or more suitable applications.

Input unit 192 and/or input unit 182 includes, for example, a keyboard, a keypad, a mouse, a touch-screen, a touch-pad, a track-ball, a stylus, a microphone, or other suitable pointing device or input device. Output unit 193 and/or output unit 183 includes, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

Memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 includes, for example, a hard disk drive, a floppy disk drive, a Compact Disk (CD) drive, a CD-ROM drive, a DVD drive, or other suitable removable or non-removable storage units. Memory unit 194 and/or storage unit 195, for example, may store data processed by device 102. Memory unit 184 and/or storage unit 185, for example, may store data processed by device 140.

In some demonstrative embodiments, devices 102 and 140 may include one or more radios to perform wireless communication between devices 102, 140, and/or one or more other wireless communication devices. For example, device 102 may include at least one radio 114, and/or device 140 may include at least one radio 144.

In some demonstrative embodiments, radios 114 and/or 144 may include one or more wireless receivers (Rx) including circuitry and/or logic to receive wireless communication signals, RF signals, frames, blocks, transmission streams, packets, messages, data items, and/or data. For example, radio 114 may include a receiver 116, and/or radio 144 may include a receiver 146.

In some demonstrative embodiments, radios 114 and/or 144 may include one or more wireless transmitters (Tx) including circuitry and/or logic to send wireless communication signals, RF signals, frames, blocks, transmission streams, packets, messages, data items, and/or data. For example, radio 114 may include a transmitter 118, and/or radio 144 may include a transmitter 148.

In some demonstrative embodiments, radios 114 and/or 144 may include modulation elements, demodulation elements, amplifiers, analog to digital and digital to analog converters, filters, and/or the like. For example, radios 114 and/or 144 may include or may be implemented as part of a wireless Network Interface Card (NIC), and the like.

In some demonstrative embodiments, radios 114 and/or 144 may include, or may be associated with, one or more antennas 107 and/or 147, respectively.

In one example, device 102 may include a single antenna 107. In other example, device 102 may include two or more antennas 107.

In one example, device 140 may include a single antenna 147. In other example, device 140 may include two or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. Antennas 107 and/or 147 may include, for example, antennas suitable for directional communication, e.g., using beamforming techniques. For example, antennas 107 and/or 147 may include a phased array antenna, a multiple element antenna, a set of switched beam antennas, and/or the like. In some embodiments, antennas 107 and/or 147 may implement transmit and receive functionalities using separate transmit and receive antenna elements. In some embodiments, antennas 107 and/or 147 may implement transmit and receive functionalities using common and/or integrated transmit/receive elements.

In some demonstrative embodiments, device 102 and device 140 may be located in a room to share content from device 102 on display device 180.

In one example, device 102 may include a laptop and device 140 may include a wireless projector located in a conference room. According to this example, a user of device 102 may share a presentation from device 102 on the wireless projector, for example, to enable one or more people in the conference room to view the presentation.

In some demonstrative embodiments, devices 102 and 140 may communicate over a wireless link 105 to stream the content from device 102 on display device 180.

In some demonstrative embodiments, devices 102 and 140 may communicate over wireless link 105, for example, to stream from video source 120 to video sink 160 the content to be displayed on display device 180.

In some demonstrative embodiments, wireless link 105 may include a Miracast link or a WiDi link.

In other embodiments, wireless link 105 may include any other wireless link configured to stream from device 102 the content to be displayed on display device 180.

In some demonstrative embodiments, the content may be private, confidential and/or sensitive.

In some demonstrative embodiments, the content may be displayed on display device 180, even if a user of device 102 leaves the room, for example, if devices 102 and/or 140 do not disconnect wireless link 105.

In some demonstrative embodiments, displaying the content of device 102 on display device 180, e.g., when the user is out of the room, may violate a privacy, security and/or confidentiality of the user and/or the content, for example, if non-authorized people enter the room after the user left the room.

In one example, device 102 may include a laptop having a confidential presentation to be displayed on a wireless projector in a conference room. According to this example, even if a user of the laptop closes the lid and/or leaves the conference room, the confidential presentation may be displayed on the wireless projector and may be exposed to other people entering the conference room after the user leaved the conference room, e.g., if device 102 does not disconnect wireless link 105.

Some demonstrative embodiments may enable device 102 to autonomously disconnect wireless link 105, for example, as soon as device 102 leaves the room, e.g., as described below.

Some demonstrative embodiments may enable device 102 to trigger disconnection of wireless link 105, for example, when the user of device 102 is out of the room and/or leaves the room, e.g., as described below.

In some demonstrative embodiments, device 102 may include a controller 124 configured to initiate the disconnection of wireless link 105.

In some demonstrative embodiments, controller 124 may be configured to initiate the disconnection of wireless link 105, for example, if device 102 is determined to be out of the room, e.g., as described below.

In some demonstrative embodiments, controller 124 may include circuitry, e.g., processor circuitry, memory circuitry, Media-Access Control (MAC) circuitry, Physical Layer (PHY) circuitry, and/or any other circuitry, configured to perform the functionality of controller 124. Additionally or alternatively, one or more functionalities of controller 124 may be implemented by logic, which may be executed by a machine and/or one or more processors, e.g., as described below.

In some demonstrative embodiments, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In some demonstrative embodiments, message processor 128 may include circuitry, e.g., processor circuitry, memory circuitry, Media-Access Control (MAC) circuitry, Physical Layer (PHY) circuitry, and/or any other circuitry, configured to perform the functionality of message processor 128. Additionally or alternatively, one or more functionalities of the proximity estimators message processor 128 may be implemented by logic, which may be executed by a machine and/or one or more processors, e.g., as described below.

In some demonstrative embodiments, at least part of the functionality of message processor 128 may be implemented as part of radio 114.

In some demonstrative embodiments, at least part of the functionality of message processor 128 may be implemented as part of controller 124.

In other embodiments, the functionality of message processor 128 may be implemented as part of any other element of device 102.

In some demonstrative embodiments, controller 124 may determine if mobile device 102 is out of the room based on audio signals received from a signal transmitter 150.

In some demonstrative embodiments, signal transmitter 150 may include any signal transmitter capable of emitting audio signals.

In some demonstrative embodiments, the audio signals may include inaudible audio signals.

In one example, the inaudible audio signals may include ultrasound audio signals, e.g., having a frequency greater than or equal to 20 kilohertz

In another example, the audio signals may include any other audio signals.

In some demonstrative embodiments, signal transmitter 150 may be part of device 140. In other embodiments, signal transmitter 150 may be implemented as any other element of system 100.

In some demonstrative embodiments, controller 124 may request signal transmitter 150 to transmit the audio signals.

In some demonstrative embodiments, controller 124 may request signal transmitter 150 to periodically transmit the audio signals.

In some demonstrative embodiments, device 102 may include an audio receiver 132 to receive the audio signals.

In some demonstrative embodiments, audio receiver 132 may include a microphone. In other embodiments, audio receiver 132 may include any other acoustic sensor.

In some demonstrative embodiments, controller 124 may request signal transmitter 150 to transmit the audio signals based on a movement of device 102.

In one example, the movement may indicate an intention of the user of device 102 to leave the room.

In some demonstrative embodiments, device 102 may include a movement sensor 134 to detect the movement of mobile device 102.

In some demonstrative embodiments, movement sensor 134 may include an accelerometer.

In other embodiments, movement sensor 134 may include any other sensor capable of detecting movement of device 102, e.g., a gyroscope, a magnetometer, a camera, an image processor, a movement detection processor, and/or the like.

In some demonstrative embodiments, controller 124 may trigger signal transmitter 150 to transmit the audio signals based on the detected movement of device 102.

In some demonstrative embodiments, controller 124 may trigger signal transmitter 150 to transmit the audio signals based on a duration of the detected movement of device 102 (“movement duration”).

In one example, controller 124 may trigger signal transmitter 150 to transmit the audio signals, for example, if the movement duration is longer than a predefined movement period, e.g., indicating a big movement of device 102, which may indicate that the user is about to leave the room.

In another example, controller 124 may not trigger signal transmitter 150 to transmit the audio signals, for example, if the movement duration is less than the predefined movement period, e.g., indicating a small movement of device 102, which may indicate that the user does not leave the room.

In some demonstrative embodiments, controller 124 may request signal transmitter 150 to stop transmitting the audio signals based on the detected movement of device 102.

In some demonstrative embodiments, controller 124 may request signal transmitter 150 to stop transmitting the audio signals, for example, if no movement is detected for a long period of time.

In one example, controller 124 may request signal transmitter 150 to stop transmitting the audio signals, for example, if no movement is detected for a period longer than a predefined period (“static period”).

In another example, controller 124 may select not to request signal transmitter 150 to stop transmitting the audio signals, for example, if no movement is detected for a period less than the static period.

In some demonstrative embodiments, controller 124 may determine whether or not mobile device 102 is out of the room based on the audio signals, e.g., received via audio receiver 132.

In some demonstrative embodiments, controller 124 may continue to determine whether or not mobile device 102, for example, as long as device 102 is not determined to be out of the room.

In some demonstrative embodiments, controller 124 may initiate the disconnection of wireless link 105, for example, if device 102 is determined to be out of the room.

In some demonstrative embodiments, radios 114 and 144 may disconnect wireless communication link 105, for example, if controller 124 determines that device 102 is out of the room.

In some demonstrative embodiments, controller 124 may request signal transmitter 150 to stop transmitting the audio signals, for example, if device 102 is determined to be out of the room.

In some demonstrative embodiments, determining whether or not device 102 is out of the room based on the audio signals may enable device 102 to disconnect wireless link 105, which may maintain privacy and/or confidentially of the content and/or the user of device 102, for example, when device 102 leaves the room.

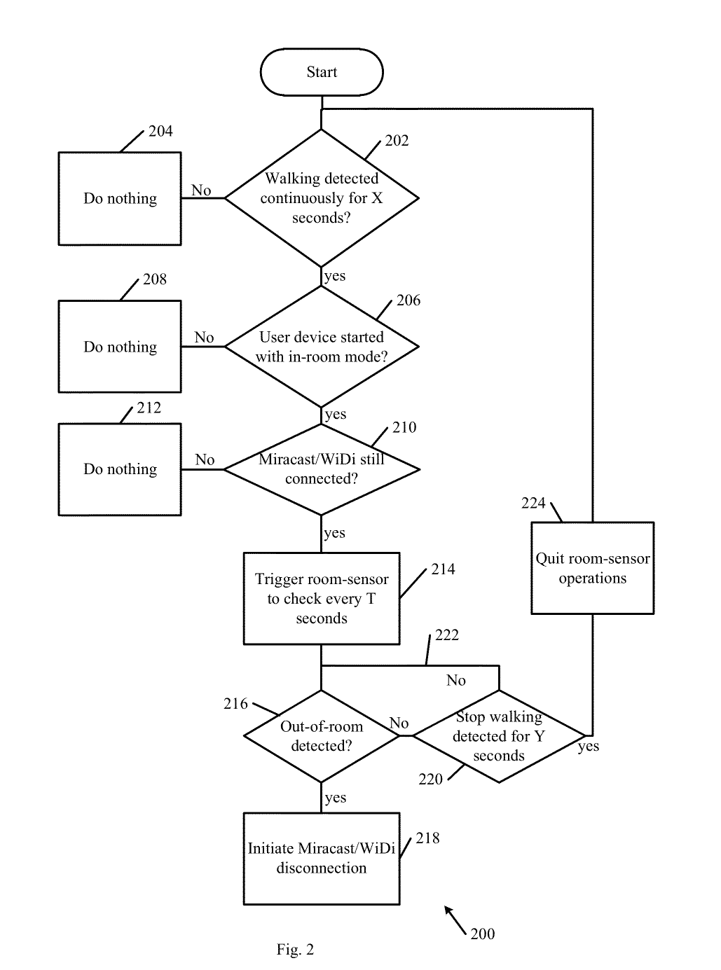

Reference is made to FIG. 2, which schematically illustrates a method of determining whether or not a mobile device is out of a room, in accordance with some demonstrative embodiments. For example, one or more of the operations of the method of FIG. 2 may be performed by a wireless communication system, e.g., system 100 (FIG. 1); a wireless communication device, e.g., device 102 (FIG. 1); a radio, e.g., radio 114 (FIG. 1); a message processor, e.g., message processors 128 (FIG. 1); a movement sensor, e.g., movement sensor 134 (FIG. 1); and/or a controller, e.g., controller 124 (FIG. 1).

As indicated at block 202, the method may include determining whether or not continuous movement is detected for a duration longer than a predefined movement period. For example, controller 124 (FIG. 1) may determine whether or not the movement is detected for a period longer than the predefined movement period, e.g., as described above.

As indicated at block 204, the method may include selecting not to perform an operation, e.g., if duration of the movement is less that the predefined movement period. For example, controller 124 (FIG. 1) may select not to trigger signal transmitter 150 to transmit the audio signals, for example, if the duration of the movement is less than the predefined movement period, e.g., as described above.

As indicated at block 206, the method may include determining whether or not the mobile device is located in a room (“t an in-room mode”). For example, controller 124 (FIG. 1) may determine whether or not device 102 (FIG. 1) is at the in-room mode, e.g., as described above.

As indicated at block 208, the method may include selecting not to perform an operation, e.g., if the mobile device is not at the in-room mode. For example, controller 124 (FIG. 1) may select not trigger signal transmitter 150 (FIG. 1) to transmit the audio signals, for example, if device 102 (FIG. 1) is not inside the room, e.g., as described above.

As indicated at block 210, the method may include determining whether or not the mobile device is connected to a wireless display via a wireless link. For example, controller 124 (FIG. 1) may determine whether or not wireless link 105 (FIG. 1) is connected, e.g., as described above.

As indicated at block 212, the method may include selecting not to perform an operation, e.g., if the wireless link is disconnected. For example, controller 124 (FIG. 1) may not need to disconnect wireless link 105 (FIG. 1), for example, if wireless link 105 (FIG. 1) is already disconnected and/or has not been established, e.g., as described above.

As indicated at block 214, the method may include triggering a signal transmitter to transmit detection signals periodically. For example, controller 124 (FIG. 1) may request signal transmitter 150 (FIG. 1) to transmit the audio signals periodically, e.g., as described above.

As indicated at block 216, the method may include determining whether or not the mobile device is out of the room. For example, controller 124 (FIG. 1) may determine whether or not device 102 (FIG. 1) is out of the room based on the audio signals, e.g., as described above.

As indicated at block 218, the method may include disconnecting the wireless communication link if the mobile device is out of the room. For example, controller 124 (FIG. 1) may initiate the disconnection of wireless link 105 (FIG. 1), for example, if device 102 (FIG. 1) is determined to be out of the room, e.g., as described above.

As indicated at block 220, the method may include determining whether or not no movement is detected for a period longer than predefined static period, e.g., if the mobile device is determined to be in the room. For example, controller 124 (FIG. 1) may determine whether or not there is no movement for a period longer than the predefined static period, for example, if device 102 (FIG. 1) is determined to be in the room, e.g., as described above.

As indicated by arrow 222, the method may include continuing to determine whether or not the mobile device is out of the room, e.g., if no movement is detected for a period less than the predefined static period. For example, controller 124 (FIG. 1) may continue to determine whether or not device 102 (FIG. 1) is out of the room, for example, if no movement is detected for a period lesser than the predefined static period, e.g., as described above.

As indicated at block 224, the method may include requesting the signal transmitter to stop transmitting the audio signals, if no movement is detected for a period longer than the predefined static period. For example, controller 124 (FIG. 1) may request signal transmitter 150 (FIG. 1) to stop transmitting the audio signals for example, if no movement is detected for the period longer than the predefined static period, e.g., as described above.

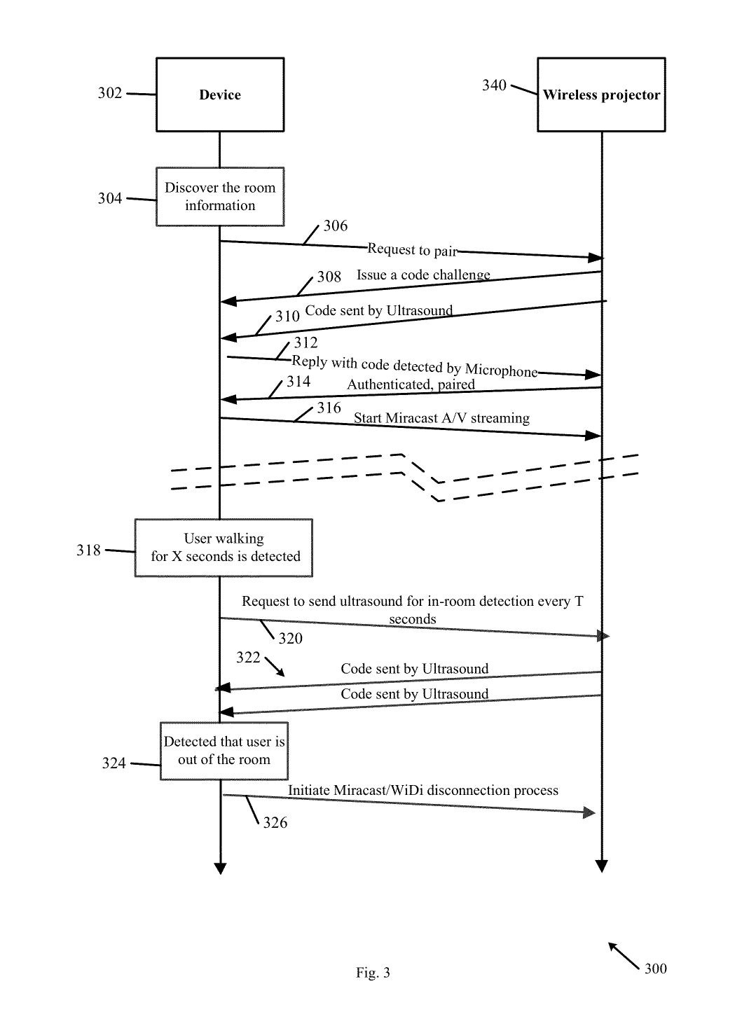

Reference is made to FIG. 3, which schematically illustrates a sequence diagram 300 of operations between a mobile device 302 and a wireless projector device 340, in accordance with some demonstrative embodiments. For example, mobile device 302 may perform the functionality of device 102 (FIG. 1), and/or wireless projector device 340 may perform the functionality of device 140 (FIG. 1).

As shown in FIG. 3, device 302 may discover (304) wireless projector 340 within the same room of device 302. For example, device 102 (FIG. 1) may discover device 140 (FIG. 1).

As shown in FIG. 3, device 302 may send a request 306 to pair with device 340. For example, device 102 (FIG. 1) may send a request to pair with device 140 (FIG. 1).

As shown in FIG. 3, device 340 may notify (308) device 302 to pair with device 302, e.g., via a code pairing procedure using audio signals. For example, device 140 (FIG. 1) may notify device 102 (FIG. 1) of the code pairing procedure using the audio signals.

As shown in FIG. 3, device 340 may send to device 302 a challenge code 310 via the audio signals to pair with device 302. For example, device 140 (FIG. 1) may send challenge code 310 via the audio signals to pair with device 102 (FIG. 1).

As shown in FIG. 3, device 302 may reply with a detected code 312 detected by an audio receiver. For example, device 102 (FIG. 1) may reply to device 140 (FIG. 1) with detected code 312 detected by audio receiver 132 (FIG. 1).

As shown in FIG. 3, device 340 may send an authentication message 314 to device 302, for example, if the challenge code and the detected code match. For example, device 140 (FIG. 1) may send authentication message 314 to device 102 (FIG. 1), e.g., if device 140 (FIG. 1) confirms pairing with device 102 (FIG. 1).

As shown in FIG. 3, device 302 may stream (316) content to device 340 via a wireless link. For example, device 102 (FIG. 1) may stream the content to device 140 (FIG. 1) via wireless link 105 (FIG. 1), e.g., as described above.

As shown in FIG. 3, device 302 may detect (318) a movement of device 302 for a duration longer than a predefined movement duration. For example, controller 124 (FIG. 1) may detect that the duration of the movement of device 102 (FIG. 1) is longer than the predefined movement duration, e.g., as described above.

As shown in FIG. 3, device 302 may request (320) device 340 to send audio signals. For example, controller 124 (FIG. 1) may request signal transmitter 150 (FIG. 1) to transmit the audio signals, e.g., as described above.

As shown in FIG. 3, device 340 may send audio signals 322, which may be received by device 302. For example, device 140 (FIG. 1) may send the audio signals to device 102 (FIG. 1), e.g., as described above.

As shown in FIG. 3, device 302 may detect (324) that device 302 is out of the room. For example, controller 124 (FIG. 1) may detect that device 102 (FIG. 1) is out of the room, for example, based on the audio signals, e.g., as described above.

As shown in FIG. 3, device 302 may initiate (326) disconnection of the wireless link, for example, if device 302 is detected to be out of the room. For example, controller 124 (FIG. 1) may initiate the disconnection of wireless link 105, for example, if device 102 (FIG. 1) is determined to be out of the room, e.g., as described above.

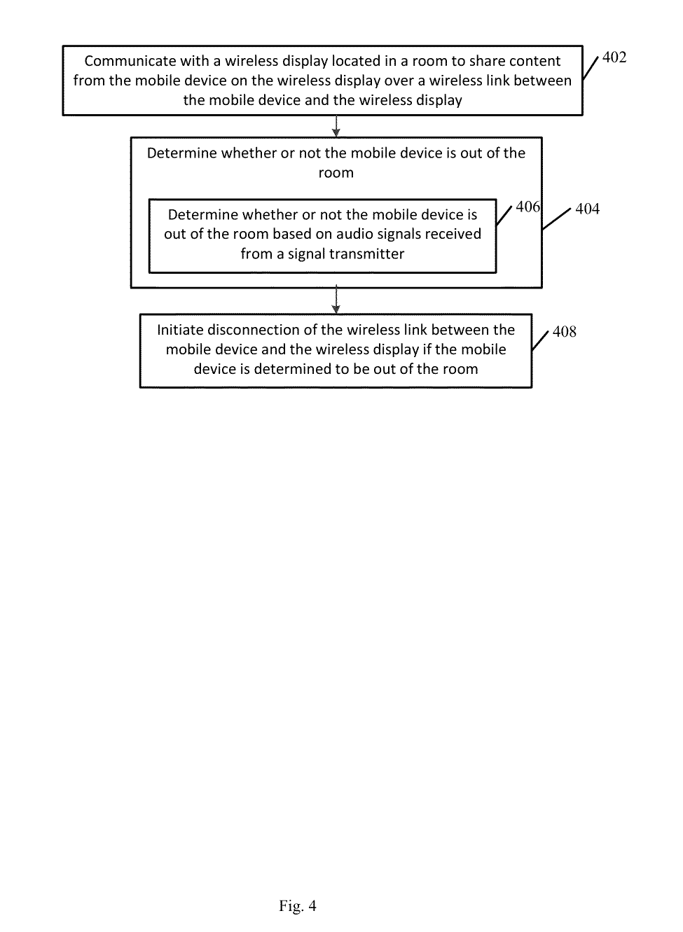

Reference is made to FIG. 4, which schematically illustrates a method of disconnecting a wireless link of a mobile device, in accordance with some demonstrative embodiments. For example, one or more of the operations of the method of FIG. 4 may be performed by a wireless communication system, e.g., system 100 (FIG. 1); a wireless communication device, e.g., device 102 (FIG. 1); a radio, e.g., radio 114 (FIG. 1); a message processor, e.g., message processor 128 (FIG. 1); and/or a controller, e.g., controller 124 (FIG. 1).

As indicated at block 402, the method may include communicating with a wireless display located in a room to share content from the mobile device on the wireless display over a wireless link between the mobile device and the wireless display. For example, radio 114 (FIG. 1) may communicate with device 140 to share the content from device 102 (FIG. 1) on display device 180 (FIG. 1) over wireless link 105, e.g., as described above.

As indicated at block 404, the method may include determining whether or not the mobile device is out of the room. For example, controller 124 (FIG. 1) may determine whether or not mobile device 102 (FIG. 1) is out of the room, e.g., as described above.

As indicated at block 406, determining whether or not the mobile device is out of the room may include determining if the mobile device is out of the room based on audio signals received from a signal transmitter. For example, controller 124 (FIG. 1) may determine whether or not mobile device 102 (FIG. 1) is out of the room based on the audio signals received from signal transmitter 150 (FIG. 1), e.g., as described above.

As indicated at block 408, the method may include initiating disconnection of the wireless link between the mobile device and the wireless display if the mobile device is determined to be out of the room. For example, controller 124 (FIG. 1) may initiate the disconnection of wireless link 105 (FIG. 1), e.g., if device 102 (FIG. 1) is determined to be out of the room, e.g., as described above.

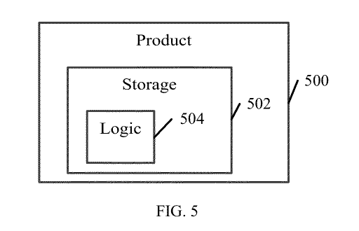

Reference is made to FIG. 5, which schematically illustrates a product of manufacture 500, in accordance with some demonstrative embodiments. Product 500 may include a non-transitory machine-readable storage medium 502 to store logic 504, which may be used, for example, to perform at least part of the functionality of device 102 (FIG. 1), radio 114 (FIG. 1), video source 120 (FIG. 1), controller 124 (FIG. 1), device 140 (FIG. 1), message processor 128 (FIG. 1), and/or to perform one or more operations of the method of FIG. 4. The phrase “non-transitory machine-readable medium” is directed to include all computer-readable media, with the sole exception being a transitory propagating signal.

In some demonstrative embodiments, product 500 and/or machine-readable storage medium 502 may include one or more types of computer-readable storage media capable of storing data, including volatile memory, non-volatile memory, removable or non-removable memory, erasable or non-erasable memory, writeable or re-writeable memory, and the like. For example, machine-readable storage medium 502 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 504 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 504 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### Examples

The following examples pertain to further embodiments.

Example 1 includes a mobile device comprising a radio to communicate with a wireless display in a room to share content from the mobile device on the wireless display over a wireless link between the mobile device and the wireless display; and a controller to determine whether or not the mobile device is out of the room, and, if the mobile device is determined to be out of the room, to initiate disconnection of the wireless link between the mobile device and the wireless display.

Example 2 includes the subject matter of Example 1, and optionally, wherein the controller is to determine if the mobile device is out of the room based on audio signals received from a signal transmitter.

Example 3 includes the subject matter of Example 2, and optionally, wherein the audio signals comprise inaudible audio signals.

Example 4 includes the subject matter of Example 2 or 3, and optionally, wherein the controller is to request the signal transmitter to transmit the audio signals.

Example 5 includes the subject matter of any one of Examples 2-4, and optionally, wherein the controller is to request the signal transmitter to periodically transmit the audio signals.

Example 6 includes the subject matter of any one of Examples 2-5, and optionally, comprising a movement sensor to detect a movement of the mobile device, wherein, based on the movement, the controller is to trigger the signal transmitter to transmit the audio signals.

Example 7 includes the subject matter of Example 6, and optionally, wherein the movement sensor comprises an accelerometer.

Example 8 includes the subject matter of Example 6 or 7, and optionally, wherein, based on a duration of the movement, the controller is to trigger the signal transmitter to transmit the audio signals.

Example 9 includes the subject matter of any one of Examples 6-8, and optionally, wherein, based on the movement, the controller is to request the signal transmitter to stop transmitting the audio signals.

Example 10 includes the subject matter of any one of Examples 1-9, and optionally, wherein the wireless link comprises a Miracast link or a Wireless Display (WiDi) link.

Example 11 includes a system including a mobile device, the mobile device comprising one or more antennas; a memory; a processor; a radio to communicate with a wireless display in a room to share content from the mobile device on the wireless display over a wireless link between the mobile device and the wireless display; a controller to determine whether or not the mobile device is out of the room, and, if the mobile device is determined to be out of the room, to initiate disconnection of the wireless link between the mobile device and the wireless display.

Example 12 includes the subject matter of Example 11, and optionally, wherein the controller is to determine if the mobile device is out of the room based on audio signals received from a signal transmitter.

Example 13 includes the subject matter of Example 12, and optionally, wherein the audio signals comprise inaudible audio signals.

Example 14 includes the subject matter of Example 12 or 13, and optionally, wherein the controller is to request the signal transmitter to transmit the audio signals.

Example 15 includes the subject matter of any one of Examples 12-14, and optionally, wherein the controller is to request the signal transmitter to periodically transmit the audio signals.

Example 16 includes the subject matter of any one of Examples 12-15, and optionally, comprising a movement sensor to detect a movement of the mobile device, wherein, based on the movement, the controller is to trigger the signal transmitter to transmit the audio signals.

Example 17 includes the subject matter of Example 16, and optionally, wherein the movement sensor comprises an accelerometer.

Example 18 includes the subject matter of Example 16 or 17, and optionally, wherein, based on a duration of the movement, the controller is to trigger the signal transmitter to transmit the audio signals.

Example 19 includes the subject matter of any one of Examples 16-18, and optionally, wherein, based on the movement, the controller is to request the signal transmitter to stop transmitting the audio signals.

Example 20 includes the subject matter of any one of Examples 11-19, and optionally, wherein the wireless link comprises a Miracast link or a Wireless Display (WiDi) link.

Example 21 includes a method to be performed at a mobile device, the method comprising communicating with a wireless display in a room to share content from the mobile device on the wireless display over a wireless link between the mobile device and the wireless display; determining whether or not the mobile device is out of the room; and if the mobile device is determined to be out of the room, initiating disconnection of the wireless link between the mobile device and the wireless display.

Example 22 includes the subject matter of Example 21, and optionally, comprising determining if the mobile device is out of the room based on audio signals received from a signal transmitter.

Example 23 includes the subject matter of Example 22, and optionally, wherein the audio signals comprise inaudible audio signals.

Example 24 includes the subject matter of Example 22 or 23, and optionally, comprising requesting the signal transmitter to transmit the audio signals.

Example 25 includes the subject matter of any one of Examples 22-24, and optionally, comprising requesting the signal transmitter to periodically transmit the audio signals.

Example 26 includes the subject matter of any one of Examples 22-25, and optionally, comprising detecting a movement of the mobile device, and, based on the movement, triggering the signal transmitter to transmit the audio signals.

Example 27 includes the subject matter of Example 26, and optionally, comprising, based on a duration of the movement, triggering the signal transmitter to transmit the audio signals.

Example 28 includes the subject matter of Example 26 or 27, and optionally, comprising, based on the movement, requesting the signal transmitter to stop transmitting the audio signals.

Example 29 includes the subject matter of any one of Examples 21-28, and optionally, wherein the wireless link comprises a Miracast link or a Wireless Display (WiDi) link.

Example 30 includes a product including one or more tangible computer-readable non-transitory storage media comprising computer-executable instructions operable to, when executed by at least one computer processor, enable the at least one computer processor to implement a method at a mobile device, the method comprising communicating with a wireless display in a room to share content from the mobile device on the wireless display over a wireless link between the mobile device and the wireless display; determining whether or not the mobile device is out of the room; and initiating disconnection of the wireless link between the mobile device and the wireless display, if the mobile device is determined to be out of the MOM.

Example 31 includes the subject matter of Example 30, and optionally, wherein the method comprises determining if the mobile device is out of the room based on audio signals received from a signal transmitter.

Example 32 includes the subject matter of Example 31, and optionally, wherein the audio signals comprise inaudible audio signals.

Example 33 includes the subject matter of Example 31 or 32, and optionally, wherein the method comprises requesting the signal transmitter to transmit the audio signals.

Example 34 includes the subject matter of any one of Examples 31-33, and optionally, wherein the method comprises requesting the signal transmitter to periodically transmit the audio signals.

Example 35 includes the subject matter of any one of Examples 31-35, and optionally, wherein the method comprises detecting a movement of the mobile device, and, based on the movement, triggering the signal transmitter to transmit the audio signals.

Example 36 includes the subject matter of Example 35, and optionally, wherein the method comprises, based on a duration of the movement, triggering the signal transmitter to transmit the audio signals.

Example 37 includes the subject matter of Example 35 or 36, and optionally, wherein the method comprises, based on the movement, requesting the signal transmitter to stop transmitting the audio signals.

Example 38 includes the subject matter of any one of Examples 30-37, and optionally, wherein the wireless link comprises a Miracast link or a Wireless Display (WiDi) link.

Example 39 includes an apparatus comprising means for communicating between a mobile device and a wireless display in a room to share content from the mobile device on the wireless display over a wireless link between the mobile device and the wireless display; means for determining whether or not the mobile device is out of the room; means for initiating disconnection of the wireless link between the mobile device and the wireless display, if the mobile device is determined to be out of the room.

Example 40 includes the subject matter of Example 39, and optionally, comprising means for determining if the mobile device is out of the room based on audio signals received from a signal transmitter.

Example 41 includes the subject matter of Example 40, and optionally, wherein the audio signals comprise inaudible audio signals.

Example 42 includes the subject matter of Example 40 or 41, and optionally, comprising means for requesting the signal transmitter to transmit the audio signals.

Example 43 includes the subject matter of any one of Examples 40-42, and optionally, comprising means for requesting the signal transmitter to periodically transmit the audio signals.

Example 44 includes the subject matter of any one of Examples 40-43, and optionally, comprising means for detecting a movement of the mobile device, and means for, based on the movement, triggering the signal transmitter to transmit the audio signals.

Example 45 includes the subject matter of Example 44, and optionally, comprising means for, based on a duration of the movement, triggering the signal transmitter to transmit the audio signals.

Example 46 includes the subject matter of Example 44 or 45, and optionally, comprising means for, based on the movement, requesting the signal transmitter to stop transmitting the audio signals.

Example 47 includes the subject matter of any one of Examples 39-46, and optionally, wherein the wireless link comprises a Miracast link or a Wireless Display (WiDi) link.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. A mobile device comprising:
a radio to communicate with a wireless display in a room to share content from the mobile device on the wireless display over a wireless link between said mobile device and said wireless display; and
a controller to determine whether or not said mobile device is out of the room, and, if said mobile device is determined to be out of the room, to initiate disconnection of said wireless link between said mobile device and said wireless display.

2. The mobile device of claim 1, wherein said controller is to determine if said mobile device is out of the room based on audio signals received from a signal transmitter.

3. The mobile device of claim 2, wherein said audio signals comprise inaudible audio signals.

4. The mobile device of claim 2, wherein said controller is to request said signal transmitter to transmit said audio signals.

5. The mobile device of claim 2, wherein said controller is to request said signal transmitter to periodically transmit said audio signals.

6. The mobile device of claim 2 comprising a movement sensor to detect a movement of said mobile device, wherein, based on said movement, said controller is to trigger said signal transmitter to transmit said audio signals.

7. The mobile device of claim 6, wherein said movement sensor comprises an accelerometer.

8. The mobile device of claim 6, wherein, based on a duration of said movement, said controller is to trigger said signal transmitter to transmit said audio signals.

9. The mobile device of claim 6, wherein, based on said movement, said controller is to request said signal transmitter to stop transmitting said audio signals.

10. The mobile device of claim 1, wherein said wireless link comprises a Miracast link or a Wireless Display (WiDi) link.

11. A system including a mobile device, the mobile device comprising:
one or more antennas;
a memory;
a processor;
a radio to communicate with a wireless display in a room to share content from the mobile device on the wireless display over a wireless link between said mobile device and said wireless display;
a controller to determine whether or not said mobile device is out of the room, and, if said mobile device is determined to be out of the room, to initiate disconnection of said wireless link between said mobile device and said wireless display.

12. The system of claim 11, wherein said controller is to determine if said mobile device is out of the room based on audio signals received from a signal transmitter.

13. The system of claim 12, wherein said audio signals comprise inaudible audio signals.

14. The system of claim 12, wherein said controller is to request said signal transmitter to transmit said audio signals.

15. The system of claim 12 comprising a movement sensor to detect a movement of said mobile device, wherein, based on said movement, said controller is to trigger said signal transmitter to transmit said audio signals.

16. A method to be performed at a mobile device, the method comprising:
communicating with a wireless display in a room to share content from the mobile device on the wireless display over a wireless link between said mobile device and said wireless display;
determining whether or not said mobile device is out of the room; and
if said mobile device is determined to be out of the room, initiating disconnection of said wireless link between said mobile device and said wireless display.

17. The method of claim 16 comprising determining if said mobile device is out of the room based on audio signals received from a signal transmitter.

18. The method of claim 17 comprising requesting said signal transmitter to transmit said audio signals.

19. The method of claim 17 comprising detecting a movement of said mobile device, and, based on said movement, triggering said signal transmitter to transmit said audio signals.

20. The method of claim 19 comprising, based on a duration of said movement, triggering said signal transmitter to transmit said audio signals.

21. A product including one or more tangible computer-readable non-transitory storage media comprising computer-executable instructions operable to, when executed by at least one computer processor, enable the at least one computer processor to implement a method at a mobile device, the method comprising:
communicating with a wireless display in a room to share content from the mobile device on the wireless display over a wireless link between said mobile device and said wireless display;
determining whether or not said mobile device is out of the room; and
initiating disconnection of said wireless link between said mobile device and said wireless display, if said mobile device is determined to be out of the room.

22. The product of claim 21, wherein said method comprises determining if said mobile device is out of the room based on audio signals received from a signal transmitter.

23. The product of claim 22, wherein said method comprises requesting said signal transmitter to transmit said audio signals.

24. The product of claim 22, wherein said method comprises detecting a movement of said mobile device, and, based on said movement, triggering said signal transmitter to transmit said audio signals.

25. The product of claim 24, wherein said method comprises, based on a duration of said movement, triggering said signal transmitter to transmit said audio signals.
